(19) United States
(12) Patent Application Publication
(10) Pub. No.: US 2002/0194059 A1
(43) Pub. Date: Dec. 19, 2002

(54) Business process control point template and method

(75) Inventors: Stephen Thomas Blocher, Ramsey, NJ (US); Deborah Jean Gurski, Hopewell Junction, NY (US); Mel B. Lombardo, Upper Saddle River, NJ (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 09/884,095

(22) Filed: Jun. 19, 2001

(51) Int. Cl. G06F 17/60

(52) U.S. Cl. 705/11

(57) ABSTRACT

A business process control point template and method are provided. In particular, the present invention provides a method for reviewing a business process to identify and address risks (i.e., control points). In addition, the present invention provides a template and method for arranging control point information. The template includes: (1) a test field for arranging a set of tests, wherein the set of tests identify risks; and (2) an action field for arranging a set of actions, wherein the set of actions address any identified risks. The template allows reviewers, auditors, or the like to efficiently access control point information and accurately perform their duties.

### BACKGROUND OF THE INVENTION

1. Technical Field

The present invention generally relates to a business process control point template and method. More particularly, the present invention relates to a template and method for reviewing business processes, wherein control point information pertaining to the business processes can be arranged in a standard format.

2. Background Art

In business, various processes are implemented to perform valuable functions. For example, a business may have the following process for paying an invoice: (1) an invoice is received; (2) the invoice is forwarded to accounts payable; (3) payment is approved; (4) a check is ordered; and (5) the check is signed and sent out. However, business processes such as this often include numerous risks. For example, a risk in the invoice process could occur when an individual approving a check is also authorized to sign the check. Accordingly, a thorough review of the business process should be implemented to identify and address such risks. For example, the risk in the invoice process could be identified by comparing the identification of the individual approving the check to the identification of the individual signing the check. If a match exists, the risk is present and should be addressed. A possible action to address this risk could be to inform corporate auditors.

Currently, reviews are not performed in this manner. In contrast, reviews are performed manually (if at all) using a litany of disparate resources. For example, one individual may be responsible for designing the actual business process, while another (i.e., a reviewer) may be responsible for identifying and/or addressing risks. However, the individual designing the business process might use resources that would benefit but are unknown to the reviewer. Moreover, documentation pertaining to the business process design could be located in a different place than documentation pertaining to the identified risks.

This becomes a problem for reviewers in that without a standard document to reference, a review of a particular business process might be implemented differently each time. These problems are magnified for an internal auditor who must attempt to audit the business processes and reviews. For example, an auditor might have to locate a first set of documents pertaining to the business process design, a second set of documents pertaining to risk identification, and a third set of documents pertaining to risk addressing actions. Accordingly, performing an audit could become both highly inefficient and inaccurate.

In view of the forgoing, there exists a need for a method for reviewing a business process that includes a standard template for arranging business process review information (e.g., business process steps, tests, actions, etc.). Such a template would allow all review information to be arranged in a standard format and stored so that reviewers, auditors, or the like can refer to the template(s) to accurately and efficiently perform their duties.

### SUMMARY OF THE INVENTION

The present invention overcomes the drawbacks of existing systems by providing a business process control point template and method. Specifically, the present invention provides a method for reviewing a business process to identify and address risks (i.e., control points). In addition, the present invention provides a template and method for arranging information pertaining to each control point. By using the method and template of the present invention, reviewers, auditors, or the like are provided with a complete resource for accurately and efficiently performing their duties.

According to a first aspect of the present invention, a method for reviewing a business process is provided. The method comprises the steps of: (1) providing a business process; (2) identifying risks in the business process as control points; and (3) arranging information pertaining to the control points in a template.

According to a second aspect of the present invention, a method for reviewing a business process is provided. The method comprises the steps of: (1) providing a business process; (2) implementing a set of tests to identify risks in the business process as control points; (3) identifying a set of actions to address the identified risks; and (4) arranging the set of tests and the identified actions in a template.

According to a third aspect of the present invention, a method for reviewing a business process is provided. The method comprises the steps of: (1) providing a business process; (2) implementing a set of tests to identify risks in the business process as control points; (3) identifying a set of actions to address the identified risks; (4) arranging the business process, the set of tests, and the identified actions in a template; and (5) auditing the control points based on the template.

According to a fourth aspect of the present invention, a method for arranging business process control point information in a template is provided. The method comprises the following steps: (1) arranging a set of tests in a test field, wherein the set of tests identifies risks in a business process; and (2) arranging a set of actions in an action field, wherein the set of actions addresses the identified risks.

According to a fifth aspect of the present invention, a method for arranging business process control point information in a template is provided. The method comprises the following steps: (1) arranging a business process in a business process field; (2) arranging a set of tests in a test field, wherein the set of tests identifies risks in the business process; and (3) arranging a set of actions in an action field, wherein the set of actions addresses the identified risks.

According to a sixth aspect of the present invention, a template for arranging business process control point information is provided. The template comprises: (1) a test field for arranging a set of tests, wherein the set of tests identifies risks in a business process; and (2) an action field for arranging a set of actions, wherein the set of actions addresses the identified risks.

According to a seventh aspect of the present invention, a template for arranging business process control point information is provided. The template comprises: (1) a business process field for arranging a business process; (2) a test field for arranging a set of tests, wherein the set of tests identifies risks in the business process; and (3) an action field for arranging a set of actions, wherein the set of actions addresses the identified risks.

According to an eighth aspect of the present invention, a template for arranging business process control point information is provided. The template comprises: (1) a business process field for arranging a business process; (2) a test field for arranging a set of tests, wherein the set of tests identifies risks in the business process; (3) an action field for arranging a set of actions, wherein the set of actions addresses the identified risks; (4) a test execution field for arranging a test entity, wherein the test entity performs the indicated set of tests; (5) an action execution field for arranging an action entity, wherein the set of action entities performs the set of actions; and (6) an audit field for arranging audit details.

According to a ninth aspect of the present invention, a program product stored on a recordable medium for arranging business process control point information in a template is provided. The program product comprises: (1) an interface for receiving business process control point information; (2) a template for arranging the received information, wherein the template comprises: (a) a test field for arranging a set of tests, wherein the set of tests identifies risks in a business process; and (b) an action field for arranging a set of actions, wherein the set of actions addresses the identified risks.

Therefore, the present invention provides a method for reviewing a business process to identify and address risks. In addition, the present invention provides a template and method for arranging control point information.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a computer system having a review system, according to the present invention.

FIG. 2 depicts a first page of a template, according to the present invention.

FIG. 3 depicts a second page of a template, according to the present invention.

FIG. 4 depicts a third page of a template, according to the present invention.

FIG. 5 depicts a fourth page of a template, according to the present invention.

FIG. 6 depicts a fifth page of a template, according to the present invention.

FIG. 7 depicts a sixth page of a template, according to the present invention.

FIG. 8 depicts a flow chart of a first method, according to the present invention.

FIG. 9 depicts a flow chart of a second method, according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience, this description will include the following sections:

I. Definitions

II. Computer System

III. Review System

IV. Template

I. Definitions

Business Process—a set of steps followed to perform a business function.

Test Entity—an individual, group of individuals, or an expert system that performs a set of tests.

Action Entity—an individual, group of individuals, or an expert system that performs a set of actions.

Control Point—a risk identified in a business process that should be addressed.

Test—a measure taken to identify risks in a business process.

Action—a measure taken to address an identified risk.

Set—one or more items.

Reviewer—an individual or group of individuals who participates in reviewing a business process.

Auditor—an individual or group of individuals who audits a control point, and/or a business process review.

II. Computer System

In general, the present invention provides a method for reviewing a business process to identify and address risks. Specifically, each identified risk is considered a control point that should be addressed. Preferably, each time a new process is designed or an existing process is modified, it is reviewed to identify control points. In addition, the present invention provides a template and method for arranging information pertaining to the identified control points. Once arranged, the template is stored. Reviewers and/or auditors can then access the stored template to efficiently and accurately perform their duties.

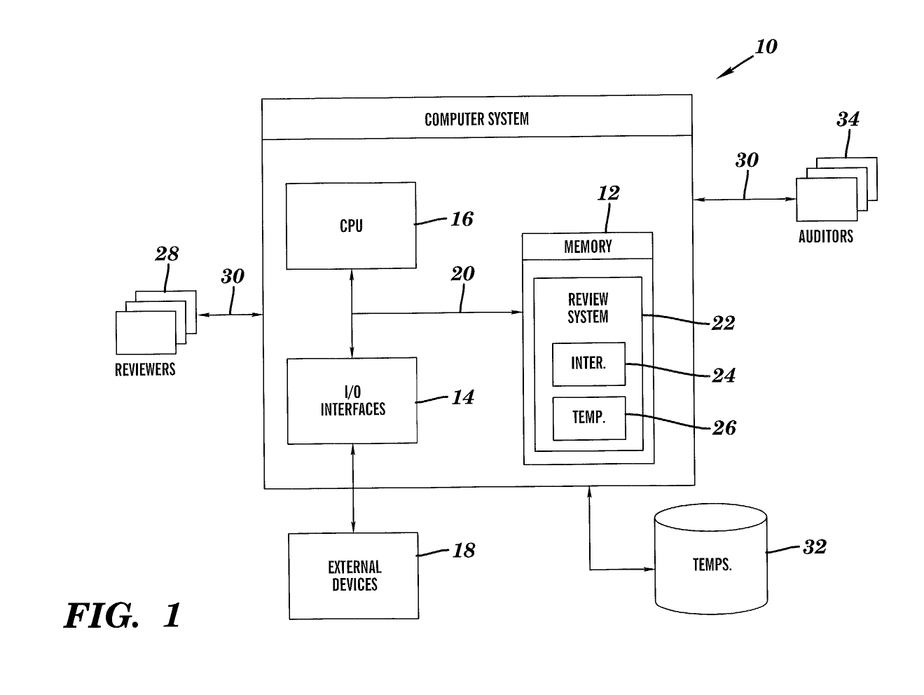

Referring now to FIG. 1, a computer/server system 10 that includes the review system 22 of the present invention is shown. The computer system 10 generally comprises memory 12, input/output interfaces 14, a central processing unit (CPU) 16, external devices/resources 18, bus 20, and database 32. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, scanner, hand held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Stored in memory 12 is review system 22 (shown in FIG. 1 as a software product). Review system 22 will be described in more detail below but generally comprises an interface 24 for inputting business process and/or control point information, and templates 26 for arranging the inputted information in a standard format. Database 32 provides storage for arranged templates 26. Information arranged in a template could include, inter alia: (1) a business process; (2) a set of tests designed to identify risks in the business process; and (3) a set of actions designed to address the identified risks. In addition, once stored in database 32, reviewers and/or auditors 34 could access templates 26. Database 32 may comprise one or more storage devices, such as a magnetic disk drive or an optical disk drive. In another preferred embodiment, database 32 includes data distributed across, for example, a local area network (LAN), wide area network (WAN) or a storage area network (SAN) (not shown). Database 32 may also be configured in such a way that one of ordinary skill in the art may interpret it to include one or more databases.

As indicated above, review system 22 preferably includes interface 24, and templates 26. Interface can be any program or the like that allows users to input information. For example, interface 24 could be Microsoft Word, Lotus WordPro, etc. Templates 26 are forms that allow all pertinent business process and/or control point information to be arranged in a standard format and stored so that reviewers 28 and/or auditors 34 can efficiently and accurately access the same. As depicted, control point information pertaining to business processes will be received by interface 24. Typically, the control point information will be input via interface 24 by a reviewer 28 performing a business process review. However, it should be understood that any individual or a group of individuals (e.g., an administrative assistant) could input the information. Once received, the information is arranged in a template 26, which can then be stored in database 32. Preferably, control point information for different business processes is arranged in separate templates. For example, control point information for business process “A” could be arranged in a first template, while control point information for business process “B” could be arranged in a second template. This allows reviewers to reference earlier reviews of a business process prior to re-review, and auditors 34 to audit business processes according to a particular area of expertise. Specifically, if auditor “A” has expertise in invoicing, he/she can access the invoice business process control point template(s) without having to access templates for other business processes. This allows the auditor to more efficiently perform his/her duties.

Communication with computer system 10 occurs via communication links 30. Communications links 30 can include a direct terminal connected to computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. As indicated above, computer system 10 according to the present invention can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

III. Review System

As indicated above, review system 22 allows business process control point information to be arranged into template 26 for efficient and accurate access by reviewers, auditors, or the like. Business process control point information includes information useful for reviewing a business process to identify and address risks. In general, a review includes multiple steps. First a business process must be provided. The business process is a set of steps followed to perform a business function. For example, the business process of paying an invoice could includes the following steps: (1) an invoice is received; (2) the invoice is forwarded to accounts payable; (3) payment is approved; (4) a check ordered; and (5) the check is signed and sent out. It should be understood, however, that this example is illustrative and not intended to be limiting. For example, the set of steps could include any quantity of steps. In addition, the business process is preferably provided in the form of a framework such as a list, design flow chart, or the like.

Once the process is provided, any risks therein should be identified. Each identified risk represents a control point that should be addressed. Preferably, a review is conducted each time a new business process is created, or an existing business process is modified. A possible risk with the invoice business process could be if the individual approving payment is also authorized to sign the check. To identify whether this risk has occurred (or will occur), a set of tests or checks is performed on the business process. The set of tests are performed by a test entity (i.e., an individual, group of individuals, or an expert system). An example of a test could be to compare the identification of the individual approving payment to the identification of the individual signing the check. For example, if employee number “123” of XZY, Inc. approved payment of invoice “456” and also signed the check, the risk exists and a control point is identified. Once a control point/risk is identified, a set of actions could be proposed and/or implemented to address the risk. A possible action for the above example could be to notify internal auditing.

The set of tests and set of actions comprise control point information. Along with other pertinent information, this information is arranged in a template 26 and stored in database 32. Preferably, a separate template is created for each identified control point. This allows a detailed history of reviews to be kept, which can be later used by reviewers 28 and auditors 34. For example, reviewers who must periodically review a business process can access the stored templates to, among other things: (1) identify any information useful for reviewing a business process; and (2) perform the review consistently (i.e., the same each time). Moreover, auditors can see precisely what was done in each review without having to reference a litany of disparate resources.

Template 26 will be described in further detail below, but preferably includes, sections/fields for arranging control point information such as the set of tests, the set of actions, and any other information helpful in implementing the control point and/or performing an audit. Auditors 34 test the control points to ensure that they are effective and/or are in compliance with any guidelines. Accordingly, the templates provide an efficient way for auditors to gather any necessary information. It should be understood that the control point could be implemented before, during, or after completion of a business process.

IV. Template

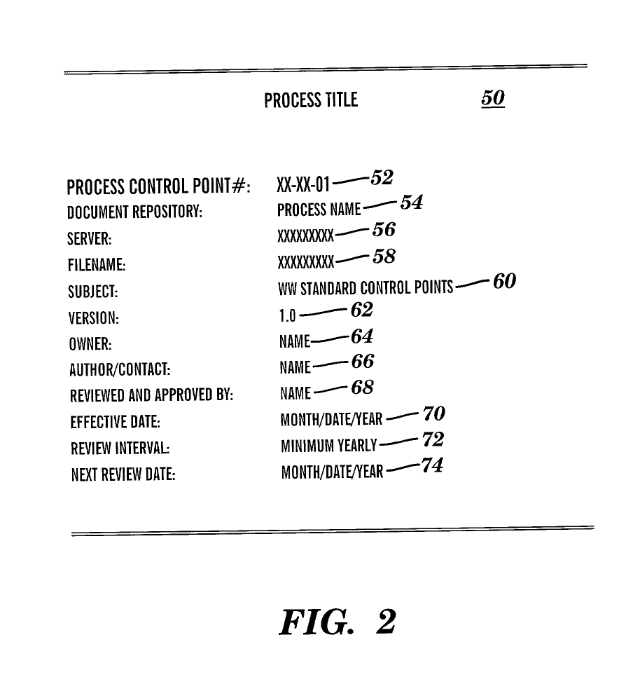

Referring now to FIGS. 2-7, an exemplary template for arranging control point and other information according to the present invention is shown. As indicated above, a separate template is preferably completed for each identified control point. Accordingly, a single business process could have numerous templates. The templates provide a review history and guidance for reviewers and auditors. This ensures that the reviews are implemented and audited efficiently and consistently each time. Moreover, the template allows auditors to audit the business process and control point from one standard document (i.e., without having to locate a litany of disparate documents). As indicated above, each time a new business process is created or an existing business process is modified, a new review is conducted and information is arranged in a template. It should be appreciated that the template shown in FIGS. 2-7 is preferably completed as an electronic document on the computer system via the interface. However, it should be understood that template could be completed as a hardcopy and scanned into the computer system via external devices for storage in the database.

FIG. 2 depicts a template cover page 50 that indicates some basic information. Process control point number field 52 indicates a unique serial number or the like that could be assigned to each control point. Document repository field 54 indicates the name of the business process that was reviewed. Server field 56 and filename field 58 detail the location where the template is stored. As indicated above, the template is preferably stored in a database, which could be on a single computer or could be distributed. Server field 56 and filename field 58 indicate the exact location of the template. Version field 62 indicates the version of the template. The version may change as the template is revised to reflect changes in the business process, identified control points, etc. Owner field 64 indicates the owner of the control point, that is, the individual or entity responsible for creating and/or administering the template. Author/Contact field 66 indicates the individual who inputted the control point information. Since each business process may have multiple control points, it will also have a corresponding number of templates. Accordingly, each control point or template may have a different owner and/or author even though they pertain to the same business process. Reviewed and approved field 68 indicates the individual who is responsible for reviewing and approving the identified control point and/or template. Effective date field 70 indicates the date the control point embodied in the template became effective. Review interval field 72 indicates how frequently the control point and/or template should be reviewed to determine whether revisions are necessary. Next review date field 74 indicates when the next review is due based on the frequency indicated in review interval field 72.

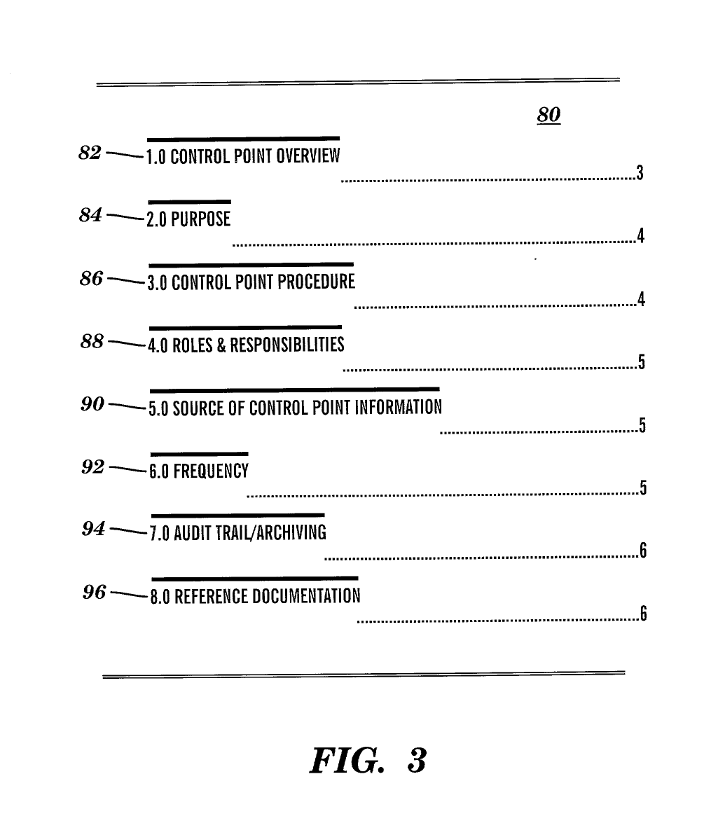

FIG. 3 shows an optional table of contents page 80 of the template. As shown, table of contents indicates the particular sections/fields of the template. The example shown in FIG. 2 includes control point overview 82, purpose 84, control point procedure 86, roles and responsibilities 88, source of control point information 90, frequency 92, audit trail/archiving 94, and reference documentation 96 fields.

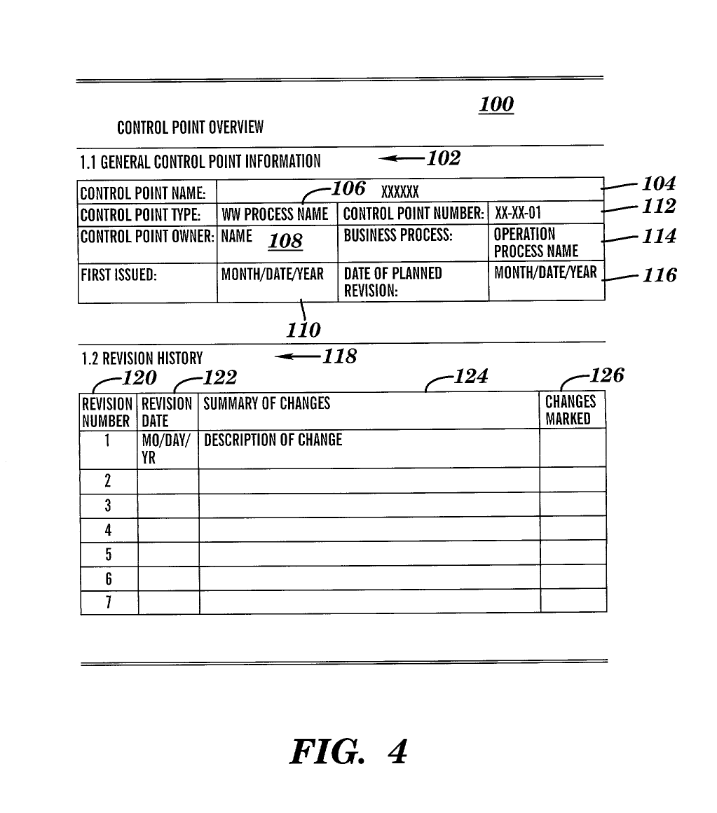

FIG. 4 shows a third page 100 of the template. As depicted, third page 100 includes general control point information section 102 and revisions history section 118. General control point information field 102 includes fields for arranging a control point name 104, a control point type 106, a control point owner 108, a date on which the control point was first issued 110, a control point number 112, a name of the business process being reviewed, and a planned revision date for the control point 116. Revision history section 118 allows for a complete history of revisions to the control point to be indicated. Specifically, revision history section 118 includes fields for arranging a revision number 120, a revision date 122, a summary of changes 124, and changes marked 126.

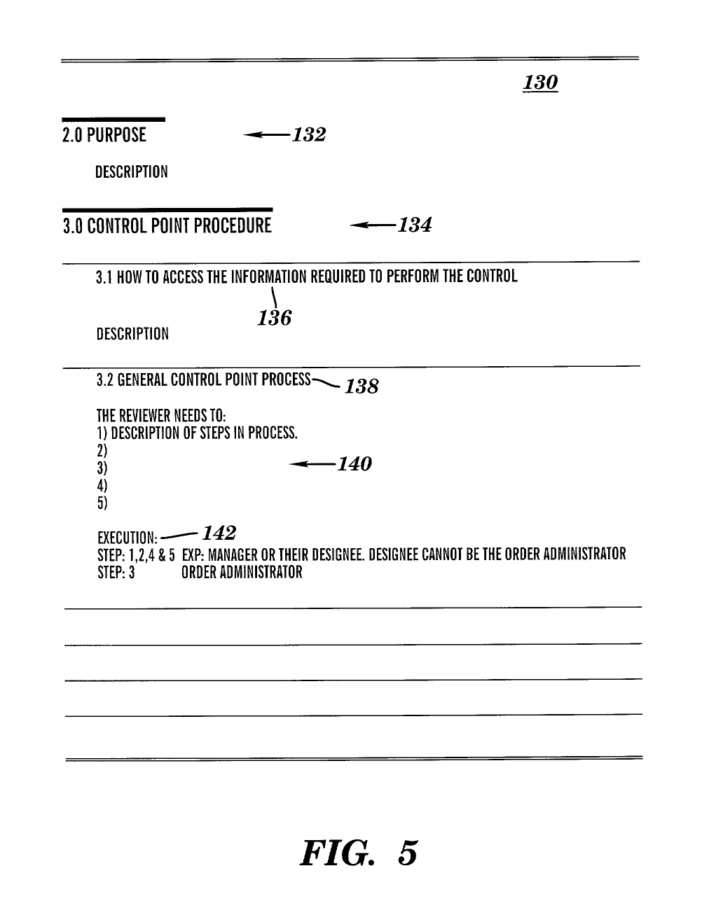

FIG. 5 depicts a fourth page 130 of the template that includes purpose section 132, and control point procedure section 134. Purpose section 132 allows the control point author to state the identified risk or control point. For example, purpose field 132 might indicate, “individuals approving payments are signing checks.” Control point procedure section 134 includes information access field 136 and control point process field 138. Information access field 136 indicates where information pertinent to the control point can be obtained. For example, information access field 136 could indicate where the employee identification numbers could be found. Preferably, information access field 136 includes a hypertext link(s) that allows direct access to pertinent information. Control point process field 138 includes a test field 140 for arranging the set of tests to be performed on the business process for identifying risks. For example, test field 140 could indicate the tests: (1) compare identification number of individual approving payment to identification number of individual signing the check; and (2) compare name of individual approving payment to name of individual signing the check. As state above, the set of tests could include one or more tests. Accordingly, test field 140 allows for many tests to be indicated. Test execution field 142 is for arranging the test entity responsible for carrying out the indicated set of tests. This could be indicated based on particular individuals, management levels, etc. As indicated above, the test entity can be one individual, a group of individuals, or an expert system. Moreover, one test entity need not be responsible for carrying out the entire set of tests. For example, each test in the set could have a different executing entity.

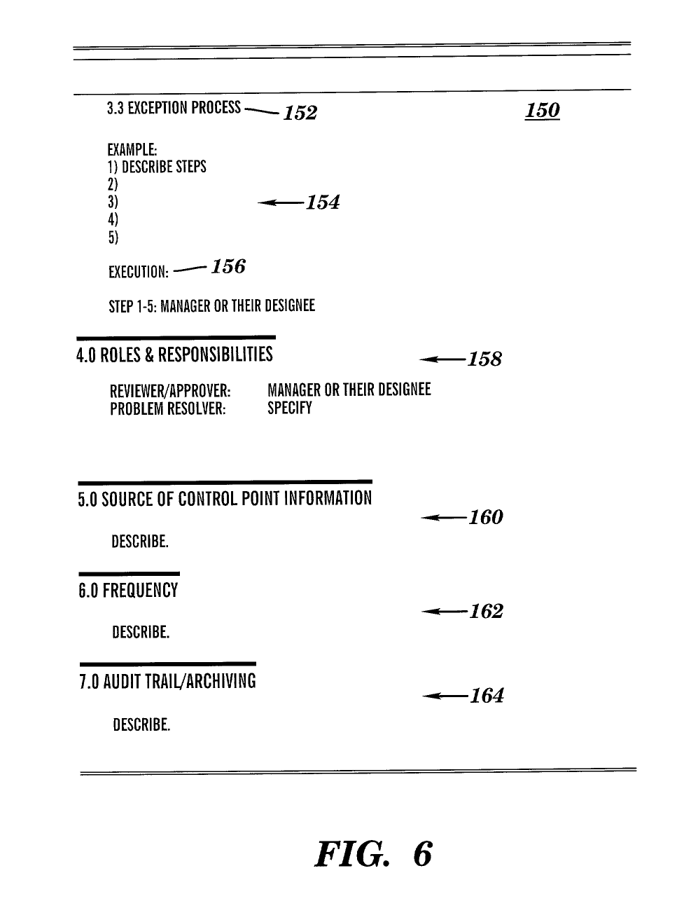

FIG. 6 depicts a fifth page 150 of the template and includes exception field 152, roles and responsibilities section 158, source of control point information section 160, frequency section 162, and audit trail/archiving section 164. Exception field 152 includes an action field 154 for arranging the set of actions (i.e., one or more) to be taken to address an identified risk. For the example above, an exemplary action could be to “notify internal auditing.” It should be appreciated, however, that since the review could be made before, during, or after a business process has actually occurred, addressing a risk could mean preventing or correcting a problem. Action execution field 156 allows an action entity to be designated for carrying out the set of actions. Similar to the above-described test execution field 142 of FIG. 5, the action entity could be an individual, group of individuals, or an expert system. Moreover, any quantity of action entities could be indicated.

Role and responsibilities section 158 indicates the role and responsibility of every entity participating in the review. For example, it could be reviewer A's responsibility to identify risks, reviewer B's responsibility to identify and implement actions to address any identified risks, and manager A's responsibility to oversee reviewers A and B. Source of control point information section 160 indicates background information on the actual business process. This allows reviewers and/or auditors to get a more clear understanding of the business process. Frequency section 162 indicates how often the control point should be implemented (e.g., monthly). Audit trail/archiving section 164 indicates how the template is recorded. For example, section 164 could indicate that a separate template is stored each time control point is identified.

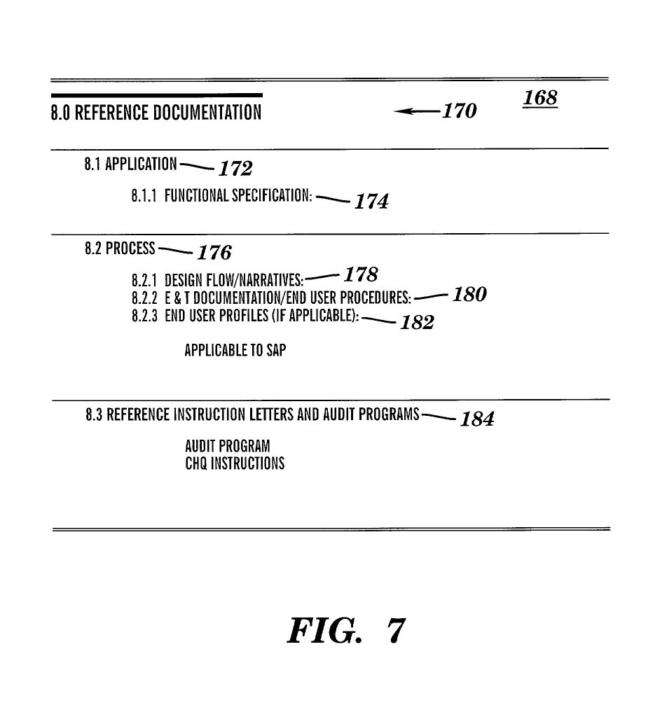

FIG. 7 depicts a sixth page 168 of the template, which includes reference documentation section 170. Reference documentation section includes application field 172, process field 176, and reference field 184. Application field 172 includes a specification field 174 for arranging functional specifications, which are any specific instructions on how to carry out the review. Process field 176 includes a design flow or process field 178 for arranging the set of steps in the business process in a more specific fashion. For example, field 178 could indicate the set of steps: (1) an invoice is received; (2) the invoice is forwarded to accounts payable; (3) payment is approved; (4) a check ordered; and (5) the check is signed and sent out. E&T field 180 indicates any education and training documentation or end user procedures that may be helpful in carrying out the review to more effectively identify and address control points. End user profiles field 182 indicates the individuals (e.g., reviewers, auditors, managers, etc.) that should receive the template. Audit field 184 provides audit details such as potential auditors of the control point, and instructions in the event of an audit. As indicated above, auditors test the control points to see if the business process is in compliance.

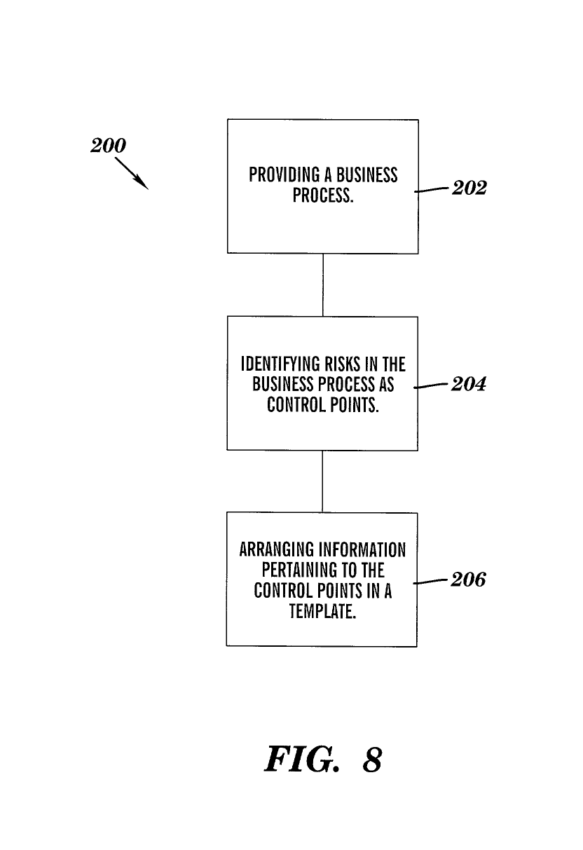

FIG. 8 depicts a flow chart of a first method 200 according to the present invention. First step 202 is to provide a business process. Second step 204 is to identify risks in the business process as control points. Third step 206 in method 200 is to arrange information pertaining to the control points in a template.

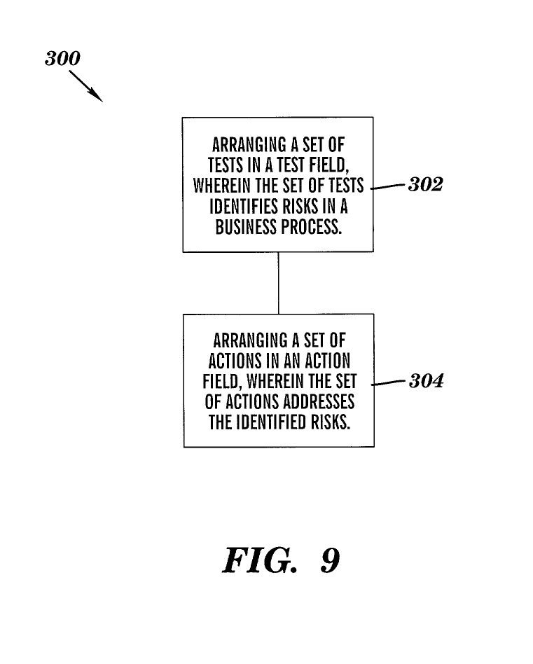

FIG. 9 depicts a flow chart 300 of a second method according to the present invention. First step 302 in method 300 is to arrange a set of tests in a test field, wherein the set of tests identifies risks in a business process. Second step 304 is to arrange a set of actions in an action field, wherein the set of actions addresses the identified risks.

The foregoing description of the preferred embodiments of this invention has been presented for purposes of illustration and description. It is not intended to be exhaustive or to limit the invention to the precise form disclosed, and obviously, many modifications and variations are possible. For example, it should be understood that the template shown in FIGS. 2-7 could include additional fields. Such modifications and variations that may be apparent to a person skilled in the art are intended to be included within the scope of this invention as defined by the accompanying claims.

1. A method for reviewing a business process, comprising the step of:
providing a business process;
identifying risks in the business process as control points; and
arranging information pertaining to the control points in a template.

2. The method of claim 1, further comprising the steps of:
identifying actions to address the risks;
arranging the identified actions in the template; and
performing an audit using the template.

3. The method of claim 1, wherein the step of identifying risks comprises the step of implementing a set of tests to identify risks in the business process.

4. The method of claim 1, wherein the information comprises:
a set of tests, wherein the set of tests identify risks in the business process; and
a set of actions, wherein the set of actions address the risks.

5. The method of claim 4, wherein the information further comprises:
a business process;
a test entity, wherein the test entity performs the set of tests;
an action entity, wherein the action entity performs the set of actions; and audit details.

6. The method of claim 5, wherein the information further comprises:
a control point name;
control point revisions;
background information; and
a control point frequency.

7. A method for reviewing a business process, comprising the steps of:
providing a business process;
implementing a set of tests to identify risks in the business process as control points;
identifying a set of actions to address the identified risks; and
arranging the set of tests and the identified actions in a template.

8. The method of claim 7, wherein the set of tests and the set of actions comprise control point information.

9. The method of claim 7, further comprising the steps of:
storing the template; and
accessing the stored template to perform an audit.

10. A method for reviewing a business process, comprising the steps of:
providing a business process;
implementing a set of tests to identify risks in the business process as control points;
identifying a set of actions to address the identified risks;
arranging the business process, the set of tests, and the identified actions in a template; and
auditing the control points based on the template.

11. The method of claim 10, wherein the implementing step comprises the step of examining steps in the business process to identify risks.

12. A method for arranging business process control point information in a template, comprising the steps of:
arranging a set of tests in a test field, wherein the set of tests identifies risks in a business process; and
arranging a set of actions in an action field, wherein the set of actions addresses the identified risks.

13. The method of claim 12, further comprising the steps of:
arranging a business process in a business process field;
arranging a test entity in a test execution field, wherein the test entity performs the set of tests;
arranging an action entity in an action execution field, wherein the action entity performs the set of actions; and
arranging audit details in an audit field.

14. The method of claim 13, further comprising:
arranging a control point name in a name field;
arranging control point revisions in a revision field;
arranging background information in an information field; and
arranging a control point frequency in an interval field.

15. The method of claim 12, further comprising the steps of:
storing the template; and
performing an audit based on the stored template.

16. A method for arranging business process control point information in a template, comprising the steps of:
arranging a business process in a business process field;
arranging a set of tests in a test field, wherein the set of tests identifies risks in the business process; and
arranging a set of actions in an action field, wherein the set of actions addresses the identified risks.

17. The method of claim 16, further comprising the steps of:
arranging a test entity in a test execution field, wherein the test entity performs the set of tests;
arranging an action entity in an action execution field, wherein the action entity performs the set of actions; and
arranging audit details in an audit field;
storing the template; and
performing an audit based on the stored template.

18. The method of claim 17, further comprising:
arranging a control point name in a name field;
arranging control point revisions in a revision field;
arranging background information in an information field; and
arranging a control point frequency in an interval field.

19. A template for arranging business process control point information, comprising:
a test field for arranging a set of tests, wherein the set of tests identifies risks in a business process; and
an action field for arranging a set of actions, wherein the set of actions addresses the identified risks.

20. The template of claim 19, further comprising:
a business process field for arranging a business process;
a test execution field for arranging a test entity, wherein the test entity performs the set of tests;
an action execution field for arranging an action entity, wherein the action entity performs the set of actions; and
an audit field for arranging audit details.

21. The template of claim 20, further comprising:
a name field for arranging a control point name;
a revision field for arranging control point revisions;
an information field for arranging background information; and
an interval field for arranging a control point frequency.

22. The template of claim 19, wherein the risks comprise control points, and wherein the set of tests and the set of actions comprise control point information.

23. A template for arranging business process control point information, comprising:
a business process field for arranging a business process;
a test field for arranging a set of tests, wherein the set of tests identifies risks in the business process; and
an action field for arranging a set of actions, wherein the set of actions addresses the identified risks.

24. The template of claim 23, further comprising:
a test execution field for arranging a test entity, wherein the test entity performs the set of tests;
an action execution field for arranging an action entity, wherein the action entity performs the set of actions; and
an audit field for arranging audit details.

25. The template of claim 24, further comprising:
a name field for arranging a control point name;
a revision field for arranging control point revisions;
an information field for arranging background information; and
an interval field for arranging a control point frequency.

26. A template for arranging business process control point information, comprising:
a business process field for arranging a business process;
a test field for arranging a set of tests, wherein the set of tests identifies risks in the business process steps;
an action field for arranging a set of actions, wherein the set of actions addresses the identified risks;
a test execution field for arranging a test entity, wherein the test entity performs the set of tests;
an action execution field for arranging an action entity, wherein the action entity performs the set of actions; and
an audit field for arranging audit details.

27. The template of claim 26, further comprising:
a name field for arranging a control point name;
a revision field for arranging control point revisions;
an information field for arranging background information; and
an interval field for arranging a control point frequency.

28. A program product stored on a recordable medium for arranging business process control point information in a template, comprising:
an interface for receiving business process control point information;
a template for arranging the received information, wherein the template comprises:
a test field for arranging a set of tests, wherein the set of tests identifies risks in a business process; and
an action field for arranging a set of actions, wherein the set of actions addresses the identified risks.

29. The program product of claim 28, wherein the template further comprises:
a business process field for arranging a business process;
a test execution field for arranging a test entity, wherein the test entity performs the set of tests;
an action execution field for arranging action entities, wherein the action entity performs the set of actions; and
an audit field for arranging audit details.

30. The program product of claim 29, wherein the template further comprises:
a name field for arranging a control point name;
a revision field for arranging control point revisions;
an information field for arranging background information; and
an interval field for arranging a control point frequency.
